(19) United States
(12) Patent Application Publication
(10) Pub. No.: US 2008/0308644 A1
(43) Pub. Date: Dec. 18, 2008

(54) Nozzle Assembly

(75) Inventors: Manfred Faubel, Rosdorf (DE); Ales Charvat, Goettingen (DE); Juergen Troe, Goettingen (DE); Bernd Abel, Dransfeld (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignees: GEORG-AUGUST-UNIVERSITAT GOETTINGEN, Goettingen (DE); Max-Planck-Gesellschaft zur Foerderung der Wissenschaften e.V.

(21) Appl. No.: 11/995,532

(22) PCT Filed: Jul. 7, 2006
(86) PCT No.: PCT/EP2006/006677

§ 371 Date: May 23, 2008

(30) Foreign Application Priority Data
Jul. 14, 2005 (DE) 10 2005 032 983.7

(51) Int. Cl. B05B 17/04; B05B 1/00

(52) U.S. Cl. 239/1; 239/589

(57) ABSTRACT

The invention relates to a nozzle assembly (1) for dispensing a fluid, especially for injecting the fluid into a vacuum chamber. The nozzle assembly (1) includes a nozzle body (2) with a continuous nozzle duct (9) and a nozzle port (10) that is embodied at the discharge end and is used for discharging the fluid, and a feeding capillary tube (8) which extends co-axially in relation to the nozzle duct (9) and is used for delivering the fluid to be injected. The feeding capillary tube (8) extends into the nozzle duct (9) of the nozzle body (2) in the direction of flow in order to reduce the dead volume.

The invention relates to a nozzle assembly for dispensing a fluid, especially for injecting the fluid into a vacuum chamber, in accordance with the preamble of the main claim.

Such a nozzle assembly is known from DE 103 08 299 A1, that can be used, e.g., in the so-called SLICED technology in order to inject a liquid jet with an analyte dissolved in it into a vacuum chamber where the analyte is examined by mass spectroscopy, which is known, e.g., from SPANGENBERG, Tim; ABEL, Bernd: “Laser-angeregte Mikrofilamente futr extreme Lichtquellen und Biomolekulanalytik” [Laser-Excited Microfilaments for Extreme Light Sources and Biomolecular Analytics], Photonik 6/2004. In the SLICED technology the analyte forms small disks in the liquid jet between which pure water is present. Therefore, the analyte is concentrated here in the liquid jet spatially onto the area of the disks, as a result of which the consumption of analyte is less than it is in a liquid jet that contains analyte in its entire volume.

However, the fact is problematic in the SLICED technology that the disk consisting of the analyte widens in time in the liquid jet in the longitudinal direction of the liquid jet, which results in a thinning of the analyte. However, it is important for the subsequent mass spectroscopic examination to keep the disks consisting of the analyte as spatially concentrated as possible in the liquid jet in order that as much analyte as possible is available for the examination in the shortest possible time. However, the undesired widening of the disks consisting of the analyte increases with the volume that is passed through inside the nozzle assembly until being ejected.

A nozzle assembly for injecting a fluid into a vacuum chamber is known from DE 198 22 674 A1 that can be used, e.g., in a mass spectrometer. This known nozzle assembly has a nozzle body that can consist, e.g., of glass, quartz or high-grade steel and receives a feeding capillary tube. However, the inside diameter of the nozzle body is larger here than the outside diameter of the feeding capillary tube so that an annular slot is present between the nozzle body and the feeding capillary tube via which a collision gas (e.g., argon or air) can be supplied while an analyte gas flow is supplied via the feeding capillary tube. The feeding capillary tube is thus not guided by the surrounding nozzle body here.

Further nozzle assemblies from other areas of technology are known from DE-PS 951 779, DE 699 17 476 T2, DE 691 03 106 T2 and DE 94 02 809 U1. However, they concern plotter nozzles, microfluidic chips, pesticide atomizers and lubrication nozzles that are not suitable as such for injecting a fluid into a vacuum chamber.

The invention is therefore based on the task of appropriately improving the initially described nozzle assembly for vacuum injection.

This task is solved by a novel nozzle assembly in accordance with the main claim.

The invention is based on the technical recognition that the initially described known nozzle assembly has a relatively large dead volume, which furthers the undesired widening of the disks consisting of the analyte.

The invention therefore comprises the general technical teaching of reducing the dead volume in the initially described known nozzle assembly.

The term of a dead volume used in the framework of the invention preferably means the entire volume that is passed through by the liquid to be injected inside the nozzle assembly.

The nozzle assembly in accordance with the invention has a nozzle body with a continuous nozzle duct and a nozzle outlet formed on the discharge side for dispensing the fluid and has a feeding capillary tube extending coaxially to the nozzle duct for delivering the fluid to be injected. The minimizing of the dead volume in accordance with the invention in the nozzle assembly is achieved in that the feeding capillary tube extends in the direction of flow into the nozzle duct of the nozzle body. The fluid to be injected therefore preferably passes only a single structural component transition in the nozzle assembly from the feeding capillary tube to the nozzle body, which results in a correspondingly lesser dead volume than in the initially described known nozzle assembly. In practice, the dead volume of the nozzle assembly in accordance with the invention is therefore less than 50 μl, 10 μl, 5 μl, 2 μl, 1 μl or even less than 0.6 μl. This is significantly less than in the initially described known nozzle assembly in accordance with patent application DE 103 08 299 A1 in which the dead volume is in the range of 0.5-1 ml.

The nozzle assembly in accordance with the invention preferably has a sealing body with a continuous duct that extends coaxially to the nozzle duct located in the nozzle body and to the feeding capillary tube and is extended through the feeding capillary tube in the assembled state.

The feeding capillary tube is therefore also extended here through the sealing body and projects as far as possible into the nozzle duct of the nozzle body in order that the smallest possible dead volume remains in the nozzle duct of the nozzle body between the discharge-side end of the feeding capillary tube and the nozzle outlet.

The sealing body preferably has a coaxial receiving bore on the discharge side that receives the nozzle body at least partially in the assembled state. The receiving bore is arranged in the discharge-side front face of the sealing body and is preferably a hollow cylinder in order that the nozzle body, that is preferably also cylindrically formed, can be axially inserted into the receiving bore of the sealing body in a simple manner.

In addition, the nozzle assembly in accordance with the invention preferably has a nozzle tube that receives the nozzle body and/or the sealing body at least partially in the assembled state, the nozzle tube having an outer thread onto which a screw cap that is arranged on the discharge side and has an inner thread can be screwed. The screwing of the screw cap to the nozzle tube makes possible an axial tightening of the sealing body in the screw coupling formed by the nozzle tube and the screw cap.

The sealing body preferably has an outer contour on the discharge side that tapers in the direction of flow whereas the screw cap has an inner contour on the entrance side that tapers in the direction of flow. When the screw cap is screwed onto the nozzle tube the screw cap is moved axially in the direction of the sealing body until the inner contour of the screw cap rests on the outer contour of the sealing body. When the screw cap is screwed on further, the sealing body is then compressed in the radial direction on its discharge-side end, as a result of which the nozzle body inserted into the receiving bore of the sealing body is frictionally fixed in the axial direction.

In order to facilitate the screwing on of the screw cap onto the nozzle tube the screw cap preferably has a shoulder for a screwing tool. The shoulder for the screwing tool can be, e.g., a radial bore arranged in the screw cap into which bore a pin can be radially inserted in order to screw the screw cap fast. However, instead of the radial bore the screw cap can also have a flat face so that the screw cap can be tightened fast with a customary screw wrench.

The nozzle tube preferably has an inner contour that is located on its end opposite direction of flow, narrows down in the direction of flow and carries an inner thread. A squeezed screw connection consisting of plastic and with an outer thread and a continuous duct for running the feeding capillary tube through can be screwed into this inner thread. During the screwing of the squeezed screw connection into the inner thread of the nozzle tube the squeezed screw connection strikes against the inner contour that tapers in the direction of flow, which has the result during a continuation of the screwing that the feeding capillary tube is fixed.

The nozzle tube preferably consists of an entrance-side tube element with an outer thread and of a discharge-side tube element with an inner thread, which two tube elements are screwed to one another in the assembled state.

The sealing body preferably has an outer contour on the entrance side that tapers counter to the direction of flow and/or the entrance-side tube element of the nozzle tube comprises an inner contour on the discharge side that widens out in the direction of flow. This has the consequence that the sealing body is pressed during the screwing of the screw cap to the nozzle tube axially against the entrance-side tube element of the nozzle tube, which results in a wedge press effect on account of the shaping of inner and outer contour.

In the nozzle assembly in accordance with the invention the nozzle tube preferably also has a shoulder for a screwing tool, which is preferably a flat face located on the outside of the nozzle tube, which makes an assembly with a customary screw wrench possible.

In the assembled state the nozzle body axially projects beyond the screw cap preferably through a central bore located in the screw cap in the direction of flow.

It should furthermore be mentioned that the nozzle tube and/or the screw cap preferably consist(s) of high-grade steel whereas the feeding capillary tube, the squeezed screw connection and/or the sealing body preferably consist of plastic but on the other hand the nozzle body preferably consists of quartz, sapphire or glass. The sealing body consisting of plastic preferably prevents a direct touching contact between the nozzle body consisting of quartz, sapphire or glass and the nozzle tube consisting of high-grade steel and the screw cap since such a material transition from quartz, sapphire or glass to high-grade steel would be very susceptible to wear.

The selection of quartz, sapphire or glass as material for the nozzle body advantageously results in a long service life. A further advantage of glass as material for the nozzle body is its good ability to be worked, since exit openings with an inside diameter of 1 μm to 1 mm can be readily realized. However, the invention is not limited to the previously mentioned materials as regards the material of the nozzle body but rather a nozzle body of plastic, for example, can also be realized in as far as the plastic used is sufficiently erosion-resistant and smooth.

It is furthermore advantageous if the nozzle body consists of a transparent material such as, e.g., glass. The transparency of the nozzle body offers the advantage here that bubbles or contaminations in the nozzle duct can be recognized by a simple visual check, which considerably simplifies the search for flaws.

The feeding capillary tube preferably has an inside diameter between 0.1 mm and 1.5 mm in the nozzle assembly in accordance with the invention and an inside diameter of 0.130 mm has proven to be advantageous.

On the other hand, the nozzle outlet preferably has an inside diameter in the range of 1 μm to 0.5 mm, any intermediate values within this value range being possible.

However, the invention is not limited as regards the inside diameter of the nozzle outlet and/or of the feeding capillary tube to the previously mentioned value ranges but rather can also basically be realized with other values.

It should furthermore be mentioned that the nozzle assembly in accordance with the invention preferably has a resistance to pressure of at least 100 bar in order to be able to inject a fluid jet into a vacuum chamber.

It is furthermore advantageous if the feeding capillary tube is tapered at its discharge-side end in the direction of flow. This makes it possible to push the feeding capillary tube in the direction of flow further into the nozzle duct of the nozzle body even though the nozzle duct tapers in the area of the nozzle outlet. As a result, the dead volume in the nozzle duct of the nozzle body decreases between the discharge-side mouth opening of the feeding capillary tube and the nozzle outlet since the feeding capillary tube can be pushed further into the nozzle duct on account of the tapering.

Finally, the invention also encompasses the use of a nozzle assembly in accordance with the invention for injecting a fluid into a vacuum chamber. The present description therefore also encompasses the examination method and the examination apparatus that are described in European patent application 04030063.4, so that the content of this patent application is to be attributed to its full extent to the present description.

Other advantageous further developments of the invention are characterized in the subclaims or are explained in detail in the following together with the description of the preferred exemplary embodiments of the invention using the figures. These show:

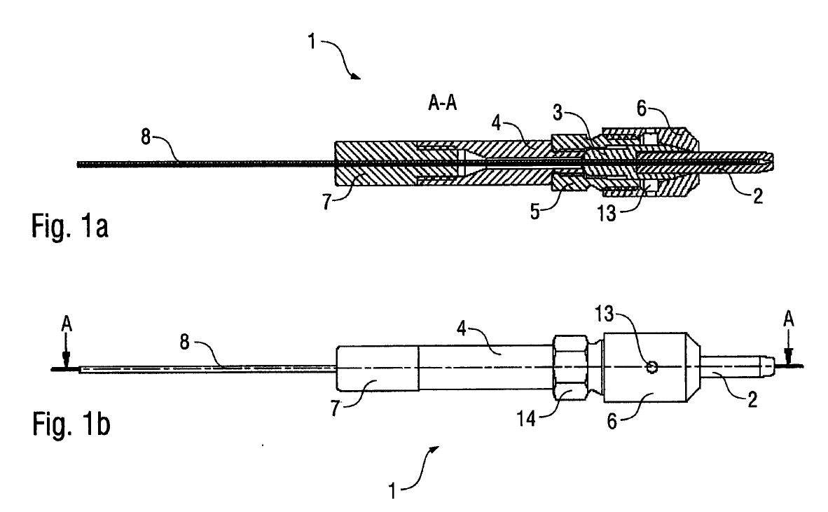

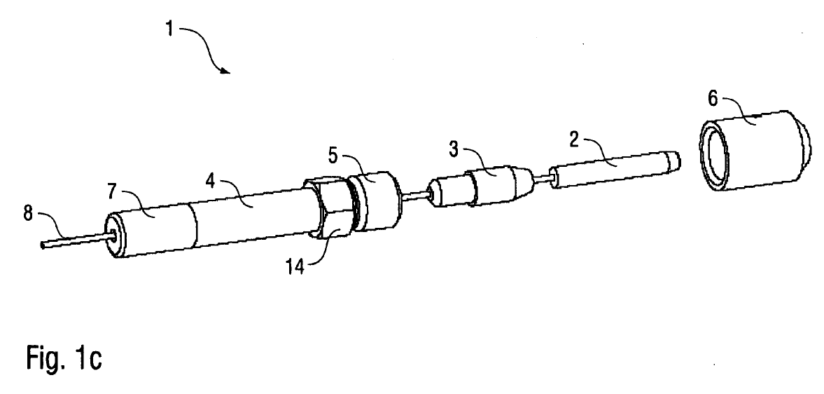

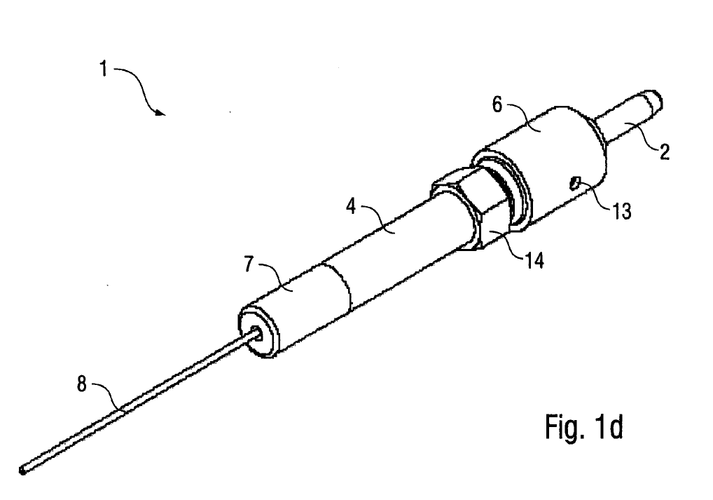

FIG. 1a a cross-sectional view of a nozzle assembly in accordance with the invention along section line A-A in FIG. 1b,

FIG. 1b a side view of the nozzle assembly in accordance with the invention in FIG. 1a,

FIG. 1c an exploded perspective view of the nozzle assembly in accordance with the invention in FIGS. 1a and 1b,

FIG. 1d a perspective view of the nozzle assembly in accordance with the invention in FIGS. 1a-1c in the assembled state, and

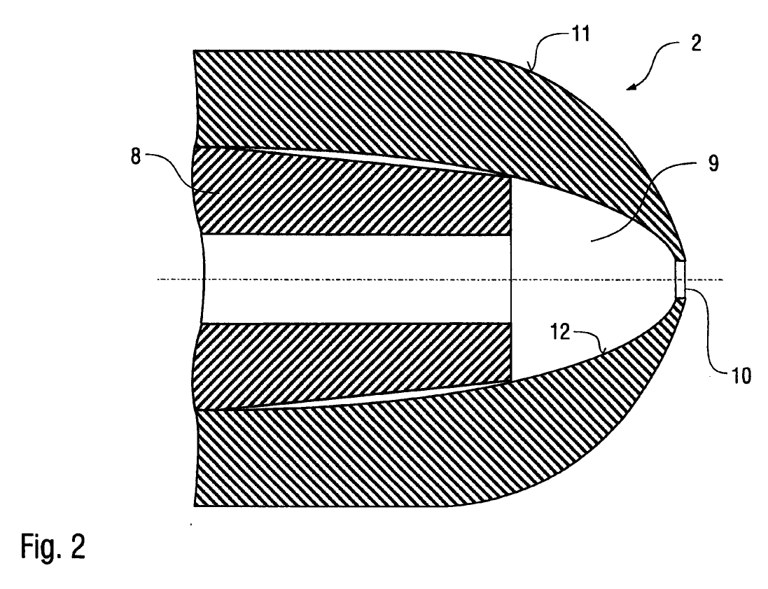

FIG. 2 a cross-sectional view of the end of the nozzle body of the nozzle arrangement in FIGS. 1a-1d.

The drawings show an exemplary embodiment of a nozzle arrangement 1 in accordance with the invention that makes it possible to inject a very thin liquid jet into a high vacuum as a target for physical-chemical examinations.

The nozzle arrangement 1 consists essentially of a nozzle body 2, a sealing body 3, a nozzle tube consisting of two tube elements 4, 5, a screw cap 6, a squeezed screw connection 7 and a feeding capillary tube 8 whose design and method of functioning is described in the following.

The feeding capillary tube 8 consists of polyetheretherketone (PEEK) and has an inside diameter d_{I}=0.130 mm and an outside diameter d_{A}=0.79 mm ( 1/32 inch). The fluid to be injected is supplied through feeding capillary tube 8 in which fluid the substances to be examined are dissolved in an analytical usage of the nozzle arrangement 1 in accordance with the invention.

In this exemplary embodiment the nozzle body 2 consists of quartz glass because quartz glass as material for the nozzle body 2 has a good ability to be worked. In addition, quartz glass is transparent so that bubbles or contaminations can be recognized by a simple visual check, which considerably simplifies the search for flaws.

The nozzle body 2 encloses a continuous nozzle duct 9, as is apparent from FIG. 2, the nozzle duct 9 emptying on the discharge side into a nozzle outlet 10 via which the liquid jet is discharged. The nozzle body has a convex outer contour 11 and a concave inner contour 12 with a parabolic form in the area of the nozzle outlet 10, which is especially favorable as regards the flow when injecting a liquid jet into a high vacuum, as has already been explained in patent application DE 103 08 299 A1. Therefore, as regards the shaping of the inner contour 1 and the outer contour 12 as well as of the nozzle outlet 10, in order to avoid repetitions patent application DE 103 08 299 A1 is referred to, whose content is to be attributed to its full extent to the present description.

In the nozzle assembly 1 in accordance with the invention the feeding capillary tube 8 is extended in the direction of flow into the nozzle duct 9 of the nozzle body 2 so that the liquid to be injected must pass only a single structural component transition from the feeding capillary tube 8 to the nozzle body 2, which reduces the dead volume.

In addition, the feeding capillary tube 8 is extended in the direction of flow as far as possible into the nozzle duct 9 of the nozzle body 2 as close as possible to the nozzle outlet 10 in order to minimize the dead volume between the discharge-side mouth opening of the feeding capillary tube 8 and the nozzle outlet 10. Therefore, in this exemplary embodiment this dead volume is less than 0.6 μl.

The extensive introduction of the feeding capillary tube 8 into the nozzle duct 9 of the nozzle body 2 is made possible by the fact that the feeding capillary tube 8 has an outer contour on its discharge-side end, which contour tapers in the direction of flow, so that the feeding capillary tube 8 can be pushed further into the also tapering nozzle duct 9 of the nozzle body 2, which further reduces the dead volume.

In the assembled state the substantially cylindrical nozzle body 2 is inserted into a hollow cylindrical receiving bore located in the discharge-side front face of the sealing body 3.

For its part the sealing body 3 is inserted into the tube element 5 that is screwed to the tube element 4, the tube element 4 carrying an outer thread at its discharge side whereas tube element 3 carries a correspondingly adapted inner thread at its entrance side.

In addition, the tube element 5 has an outer thread on its discharge side onto which thread a correspondingly adapted inner thread of the screw cap 6 can be screwed. Thus, when the screw cap 6 is being screwed onto the outer thread of the tube element 6 an axial tightening takes place between the tube element 5 and the screw cap 6. This axial tightening results in a radial pressing force of the screw cap 6 onto the sealing body 3 since the sealing body 3 has an outer contour that tapers in the direction of flow, whereas the screw cap 6 has an inner contour that tapers in the direction of flow, so that a wedge press effect is produced on account of the cooperation of outer and inner contour of the sealing body 3 and of the screw cap 6.

The two tube elements 4, 5 and the screw cap 6 consist here of high-grade steel and the sealing body 3 consisting of plastic prevents a direct touch contact between the screw cap 6 and the nozzle body 2 consisting of quartz glass since such a pairing of material would be very susceptible to mechanical wear.

Furthermore, the screw cap 6 has a radial bore 13 into which an assembly pin can be introduced in order to screw the screw cap 6 to the tube element 5.

In order to screw the tube element 5 to the tube element 4 the tube element 5 has a flat face on its outer side so that the screwing of the tube element 5 to the tube element 4 can take place with a customary screw wrench.

The tube element 4 has an inner contour on its entrance side that tapers in the direction of flow. In addition, the tube element 4 has an inner thread there into which an outer thread of the squeeze screw connection 7 can be screwed so that the squeeze screw connection 7 strikes, when being screwed in, the inner contour of the tube element 4, which contour tapers in the direction of flow, which results in a radially directed pressing force.

The invention is not limited to the previously preferred exemplary embodiment but rather a plurality of variants and modifications are possible that also make use of the inventive concept and therefore fall within the scope of protection.

1-25. (canceled)

26. A nozzle assembly for dispensing a fluid, said nozzle assembly being adapted for injecting the fluid into a vacuum chamber, and comprising:
a) a nozzle body with a continuous nozzle duct and a nozzle outlet formed on a discharge side for dispensing the fluid; and
b) a feeding capillary tube extending coaxially to the nozzle duct for delivering the fluid to be injected, wherein the feeding capillary tube extends in a direction of flow into the nozzle duct of the nozzle body.

27. The nozzle assembly according to claim 26, wherein the fluid to be injected passes only a single structural component transition in the nozzle assembly from the feeding capillary tube to the nozzle body.

28. The nozzle assembly according to claim 26, comprising a sealing body with a continuous duct extending coaxially to the nozzle duct located in the nozzle body and to the feeding capillary tube, said feeding capillary tube being extended through the continuous duct in an assembled state.

29. The nozzle assembly according to claim 28, wherein the sealing body has a coaxial receiving bore on the discharge side that receives the nozzle body at least partially in the assembled state.

30. The nozzle assembly according to claim 28, comprising:
a) a nozzle tube that receives the nozzle body and the sealing body at least partially in the assembled state, the nozzle tube having an outer thread; and
b) a screw cap with an inner thread adapted to screw on to the outer thread of the nozzle tube.

31. The nozzle assembly according to claim 30, wherein the sealing body has an outer contour on the discharge side that tapers in the direction of flow whereas the screw cap has an inner contour at an entrance side that tapers in the direction of flow.

32. The nozzle assembly according to claim 30, wherein the screw cap has a shoulder for a screwing tool.

33. The nozzle assembly according to claim 32, wherein the shoulder for the screwing tool is a radial bore arranged in the screw cap.

34. The nozzle assembly according to claim 30, wherein
a) the nozzle tube has an inner contour at an entrance side that tapers in the direction of flow and carries an inner thread,
b) a squeezed screw connection with a continuous duct for running the feeding capillary tube through and with an outer thread is screwed into the inner thread of the nozzle tube.

35. The nozzle assembly according to claim 30, wherein the nozzle tube comprises an entrance-side tube element with an outer thread and of a discharge-side tube element with an inner thread, the two tube elements being screwed to one another in the assembled state.

36. The nozzle assembly according to claim 35, wherein
a) the sealing body has an outer contour at the entrance side that tapers counter to the direction of flow and
b) the entrance-side tube element of the nozzle tube has an inner contour at the discharge side that widens out in the direction of flow.

37. The nozzle assembly according to claim 30, wherein the nozzle tube has a shoulder for a screwing tool.

38. The nozzle assembly according to claim 37, wherein the shoulder for the screwing tool is a flat face located on the outside of the nozzle tube.

39. The nozzle assembly according to claim 30, wherein in the assembled state the nozzle body axially protrudes beyond the screw cap through a central bore located in the screw cap in the direction of flow.

40. The nozzle assembly according to claim 30, wherein the nozzle tube and the screw cap consist of high-grade steel.

41. The nozzle assembly according to claim 34, wherein the feeding capillary tube, the squeezed screw connection and the sealing body consist of plastic.

42. The nozzle assembly according to claim 26, wherein the nozzle body consists of a heat-conductive material.

43. The nozzle assembly according to claim 26, wherein the nozzle body consists of a material selected from a group consisting of quartz, sapphire and glass.

44. The nozzle assembly according to claim 26, wherein the nozzle body consists of a transparent material.

45. The nozzle assembly according to claim 26, wherein the feeding capillary tube has an inside diameter between 0.1 mm and 1.5 mm.

46. The nozzle assembly according to claim 26, wherein the nozzle outlet has an inside diameter in the range of 1 μm to 0.5 mm.

47. The nozzle assembly according to claim 26, comprising a resistance to pressure of at least 100 bar.

48. The nozzle assembly according to claim 26, comprising a dead volume which is less than a limit selected from a group consisting of 2 μl, 1 μl and 0.6 μl.

49. The nozzle assembly according to claim 26, wherein
a) the nozzle duct located in the nozzle body tapers in the area of the nozzle outlet and
b) the feeding capillary tube tapers at its discharge side.

50. A method for injecting a fluid into a vacuum chamber, said method comprising providing a nozzle assembly according to claim 26, and injecting the fluid through the nozzle and into the vacuum chamber.
